(19) United States
(12) Patent Application Publication
(10) Pub. No.: US 2005/0235157 A1
(43) Pub. Date: Oct. 20, 2005

(54) Program recommendation device and method using rough fuzzy multi layer perceptron (mlp) in electronic program guide (epg) application

(76) Inventors: Yong-Ju Cho, Seoul (KR); Sang-Woo Ahn, Daejeon-city (KR); Ki-Sun Shin, Daejeon-city (KR); Jin-Soo Choi, Daejeon-city (KR); Jin-Woong Kim, Daejeon-city (KR)

Correspondence Address: Blakely Sokoloff;Taylor & Zafman, 7th Floor, 12400 Wilshire Boulevard, Los Angeles, CA, 90025, US

(21) Appl. No.: 10/514,641

(22) PCT Filed: May 16, 2003
(86) PCT No.: PCT/KR03/00982

§ 371 Date: Jun. 17, 2005

(30) Foreign Application Priority Data
May 16, 2002 (KR) 10-2002-0027015

(51) Int. Cl. H04K 1/00

(52) U.S. Cl. 713/183

(57) ABSTRACT

Disclosed is a program recommendation system and method which receive PSIP/SI and programming information on digital broadcasting and provide a program recommendation service to viewers in an EPG application. The system receives personal information in order to set information of each viewer, confirms the received PSIP/SI information, and generates watching information through a viewer watching TV, in a predetermined format. In addition, the system inputs the generated watching information to a database, converts watching information of each viewer which is stored in the database input unit into divided input patterns using a fuzzy membership function to analyze the input patterns, and extracts information on a program with a high degree of preference from the analyzed result. Furthermore the system outputs preference program information of each viewer on a screen in order to recommend a program.

### CROSS REFERENCE TO RELATED APPLICATION

This application is based on Korea Patent Application No. 2002-27015 filed on May 16, 2002 in the Korean Intellectual Property Office, the content of which is incorporated herein by reference.

### BACKGROUND OF THE INVENTION

(a) Field of the Invention

The present invention relates to digital TV. More particularly, the present invention relates to a system and method for confirming PSIP/SI and programming information, received through a predetermined broadcasting receiver of digital TV, to automatically recommend a broadcasting program a viewer prefers.

(b) Description of the Related Art

Prior arts are limited to a technique of simply receiving PSIP/SI information using an EPG (Electronic Program Guide) to display a program table on a screen in various forms, and program searching and filtering devices, and a technique of automatically recommending a program using personal program preference information has not yet been proposed.

### SUMMARY OF THE INVENTION

It is an object of the present invention to provide a technique of automatically generating data of a viewer's propensity to watch TV programs to construct and utilize a database, to provide a program recommendation service.

In one aspect of the present invention, a program recommendation system in an EPG application, which receives PSIP/SI and programming information on digital broadcasting and provides a program recommendation service to viewers in an EPG application, comprises a personal information setting unit for receiving personal information of each viewer and extracting viewer's information; a PSIP/SI information confirmation and watching information generation unit for confirming PSIP/SI information received from the outside and generating viewer's watching information of the personal information setting unit in a predetermined format when a viewer watches TV; a database input unit for storing the watching information in an inner storage unit; a preference information processor for converting watching information of each viewer, stored in the database input unit, into divided input patterns using a fuzzy membership function and analyzing the input patterns, to extract information on a program with a high degree of preference from the analyzed result; and a screen output unit for outputting preference program information of each viewer, on a screen.

In another aspect of the present invention, a program recommendation method in an EPG application, which receives PSIP/SI and programming information on digital broadcasting and provides a program recommendation service to viewers in an EPG application, comprises a first step of receiving personal information in order to set information of each viewer; a second step of confirming the received PSIP/SI information and generating watching information through a viewer watching TV in a predetermined format; a third step of inputting the generated watching information to a database; a fourth step of converting watching information of each viewer, stored in the database input unit, into divided input patterns using a fuzzy membership function, analyzing the input patterns, and extracting information on a program with a high degree of preference from the analyzed result; and a fifth step of outputting preference program information of each viewer to a screen in order to recommend a program.

### BRIEF DESCRIPTION OF THE DRAWINGS

The accompanying drawings, which are incorporated in and constitute a part of the specification, illustrate an embodiment of the invention, and together with the description, serve to explain the principles of the invention:

FIG. 1 illustrates the configuration of a program recommendation system according to the present invention;

FIG. 2 illustrates a program recommending procedure of the program recommendation system according to the present invention;

FIG. 3 illustrates a preference information generation reference table;

FIG. 4 illustrates a preference information pattern table;

FIG. 5 illustrates a pattern discerning table;

FIG. 6 illustrates a fuzzy membership function;

FIG. 7 illustrates a neural network; and

FIG. 8 illustrates the composition of a picture on a screen.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

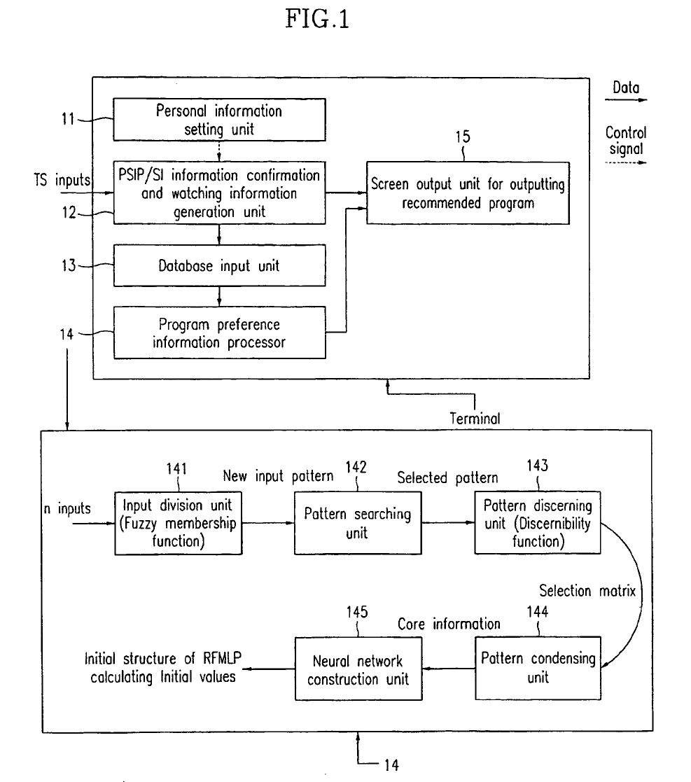

FIG. 1 illustrates the configuration of a system for providing a program recommendation service to viewers according to the present invention.

Referring to FIG. 1, a program recommendation system that provides a program recommendation service to viewers using RFMLP (Rough Fuzzy Multi Layer Perceptrons) according to an embodiment of the present invention includes a personal information setting unit 11 for providing personal information of each viewer, a watching information generation unit 12 for confirming PSIP/SI information provided by data broadcasting and generating information related to a viewer watching TV (watching information), a database input unit 13 for storing the watching information in a database, a personal program preference information processor 14 for processing each viewer's watching information stored in the database, and a screen output unit 15 for outputting information to a screen in order to recommend programs for each viewer based on the processed preference information.

The operation of the program recommendation system having the aforementioned configuration is explained below.

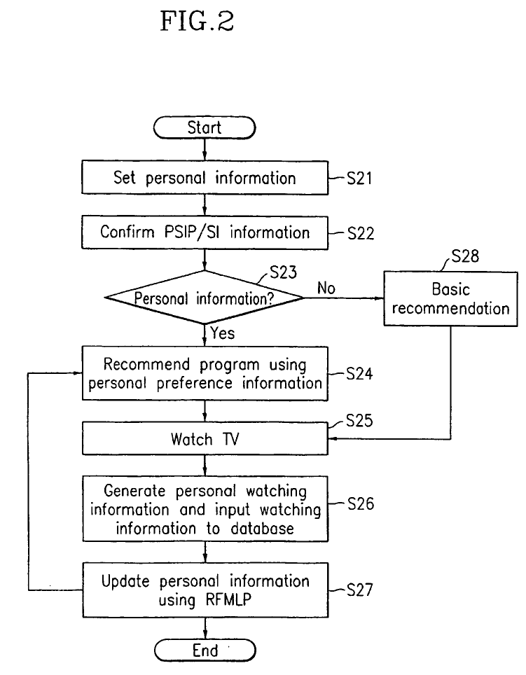

FIG. 2 illustrates a procedure showing a method of providing a program recommendation service using RFMLP according to an embodiment of the present invention.

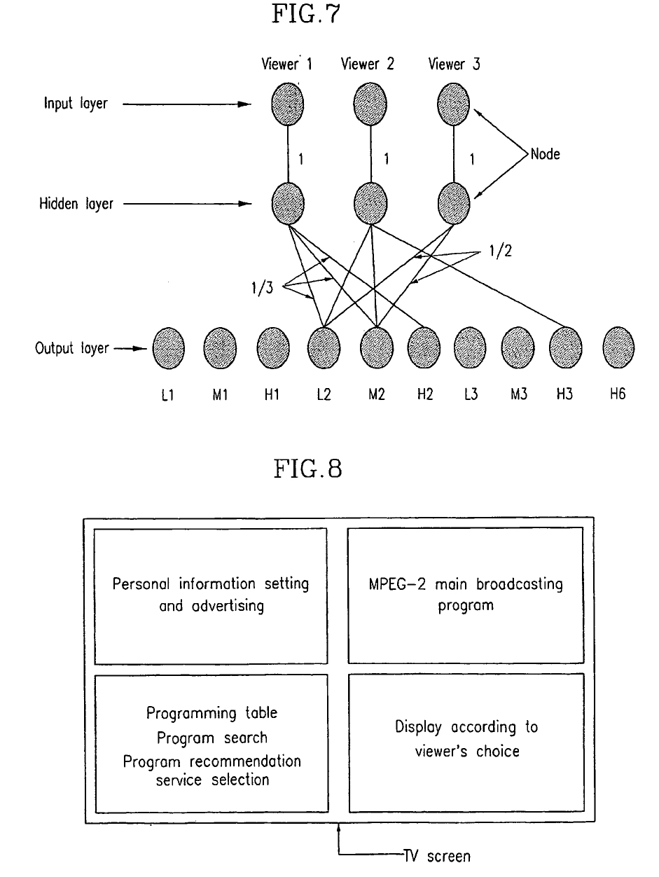

First of all, personal information is set on the screen shown in FIG. 8 to watch TV at the step S21, and the PSIP/SI information analysis unit 12 receives PSIP/SI on digital broadcasting at the step S22. According to whether personal information exists or not at the step S23, a program is recommended at the step S24 or a basic recommendation is provided at the step S28.

After the program recommendation service is provided, a corresponding viewer watches TV at the step S25. The watching information generator 12 generates new program watching information when the viewer watches TV and inputs the new program watching information into the database at the step S26. The personal program preference information processor 14 processes the personal program preference information at the step S27. The processed information is displayed to the viewer through the screen output unit 15 when a program the viewer prefers is broadcast later.

The operation of the program recommendation system having the above-described configuration is hereinafter explained in more detail.

First, the personal information setting unit 11 performs an initialization process at a terminal, for the purpose of restricting programs according to viewer's sex and age and recommending preference information of each viewer.

Each viewer inputs his/her ID and password to log in the terminal. Log-in can be carried out personally, by family, or by group. Then, the PSIP/SI information confirmation and watching information generation unit 12 confirms PSIP/SI information provided by data broadcasting and generates watching information through a viewer watching TV in RFMLP input format. The PSIP/SI information includes not only a programming table for each channel that is currently provided, and program rating information, but also additional information such as the genre and performer of each program, and the day when each program is broadcast.

The database input unit 13 inputs information on programs each viewer watches to the database.

The personal program preference information processor 14 includes an input division unit 141, a pattern searching unit 142, a pattern discerning unit 143, a pattern condensing unit 144, and a neural network construction unit 145. The operation of the personal program preference information processor is as follows.

The personal program preference information processor 14 receives personal program preference information stored in the database input unit 13 to process each viewer's preference information through a series of devices constructed of RFMLP.

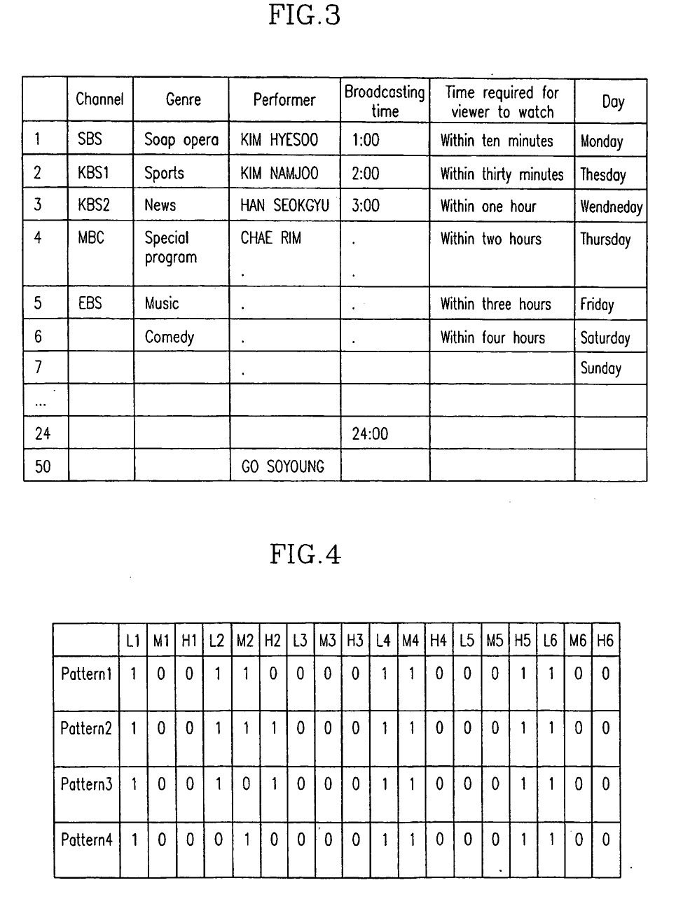

The input division unit 141 accepts personal program preference information stored in the database input unit 13 as inputs (6×1) to generate new divided input patterns using a fuzzy membership function. In this embodiment, though there are six input variables, as shown in the preference information generation reference table of FIG. 3, the number of input variables can be increased. Referring to FIG. 3, input information includes items such as channel, genre, performer, broadcasting time, period of time required for a viewer to watch the program (watching time), and broadcasting day, each of the items being provided with a number. For example, when it is assumed that the program that a certain viewer watched for one hour at three o'clock on Monday was a soap opera broadcast by MBC and the leading actress thereof is Kim Hyesoo, preference information of the viewer is 4,1,1,3,3,1 according to the order of input information. This 6×1 information is divided into 18×1 through low (L), medium (M), and high (H) functions having a Gaussian distribution, as shown in FIG. 6.

Each input is set to 0 or 1 using a designated threshold. In the case that the preference information generation reference table value of the first one of the six preference information items, which is the channel, corresponds to 4 (MBC), for instance, the degrees of membership become approximately 0.1, 0.6, and 0.9 through high, medium, and low functions, respectively, as shown in FIG. 6. That is, one item is divided into three. Then, each of the degrees of membership is represented as 0 and 1 on the basis of the threshold, 6. In this case, 0.1, 0.6, and 0.9 become 0, 1, and 1. When a series of procedures are applied to each item, the six items are represented by eighteen items.

For reference, when one program is watched, one pattern having six items is generated.

The pattern searching unit 142 selects the pattern having the highest frequency among the 18×1 input values obtained through the input division unit 141. For reference, when multiple programs are viewed, multiple patterns are generated, and patterns of preference programs among the multiple patterns occupy a large part of the input patterns. These patterns can be programs having a high degree of preference. The pattern searching unit searches a pattern that occupies the largest part of the input patterns. In this embodiment, four patterns having high frequency are sequentially shown as an example in FIG. 4.

The pattern discerning unit 143 detects a difference among the patterns using a discernibility function, to output the difference in the form of combinations of OR (v) and And (\hat{ }). Here, the result represents only the difference, so that the patterns identical to each other correspond to 0.

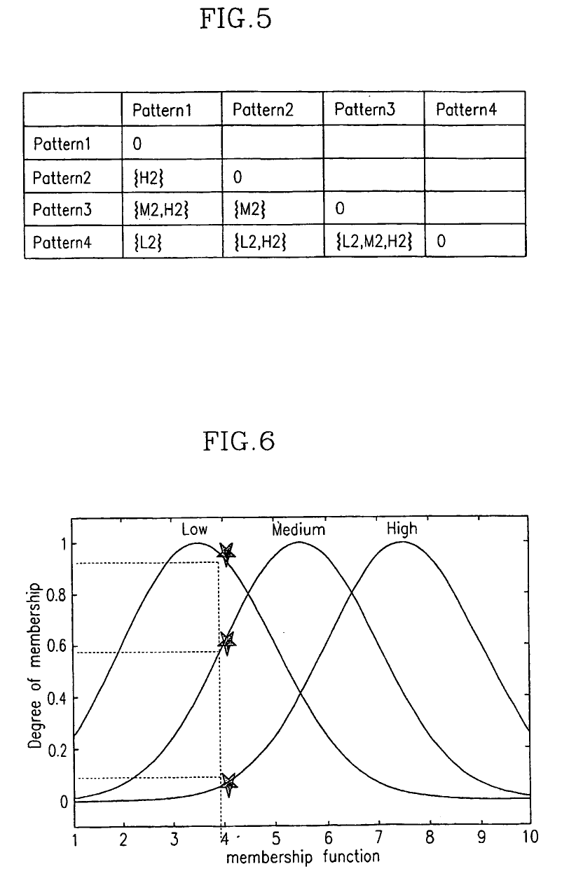

The resultant information with respect to the viewer in this case, H2\hat{ }M2\hat{ }L2\hat{ }(M2vH2)\hat{ }(L2vH2)\hat{ }(L2vM2vH2), is outputted through the pattern discerning unit 143. This corresponds to the Anded result of all the results of FIG. 5.

The pattern condensing unit 144 condenses the result of the pattern discerning unit 143 through operations. The result of the pattern discerning unit becomes (L2\hat{ }M2\hat{ }H2) through operations. This information plays an important part in extraction of a viewer's preference program information and it is transmitted to the neural network construction unit 145 for processing preference information to be used for constructing the initial structure of a neural network.

The neural network construction unit 145 constructs the initial structure of the neural network using the operation result of the pattern condensing unit 144 and trains the neural network using the patterns of the database, to process preference information of viewers. As shown in FIG. 7, the neural network construction unit 145 includes one input layer, one hidden layer, and one output layer. The viewer 1 having the aforementioned information corresponds to L2, M2, and H2 so that the initial value to each node becomes ⅓. Furthermore, since the program the viewer prefers can be discerned with the nodes L2, M2, and H2, calculations for input nodes other than the nodes L2, M2, and H2 are not needed. That is, a period of time required for training the neural network can be reduced compared to the case of using the structure of a conventional basic neural network. Thus, it is possible to make up for the weak points in efficiency of the neural network structure.

The neural network construction unit 145 processes preference information of each viewer at any time through a series of procedures to output the preference information of each viewer to the screen output unit when the viewer turns on his terminal to log in.

The screen output unit 15 outputs viewer's program preference information updated through the neural network construction unit 145 on the screen. FIG. 8 illustrates the composition of a picture displayed on the screen, which provides information on the TV screen through the screen output unit 15. When an MPEG-2 main broadcasting program is shown on the entire screen, it can be reduced to a quarter of the entire screen at the request of a viewer to display personal information and various functions to allow the viewer to easily obtain information he wants, as shown in FIG. 8. The position of each of the parts of the composition of the picture shown in FIG. 8 can be changed.

The program recommendation service is provided to viewers according to the aforementioned procedure so that the viewers can obtain information on programs they prefer automatically or manually (button click).

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the present invention receives data about a viewer's propensity to watch TV programs to provide a program recommendation service. Accordingly, users can be provided with developed and convenient broadcasting services in interactive digital broadcasting.

1. A program recommendation system in an EPG application, which receives PSIP/SI (program and system interrupt)/(system information) and programming information on digital broadcasting and provides a program recommendation service to viewers in the EPG application, the system comprising:
a personal information setting unit for receiving personal information of each viewer and extracting viewer's information;
a PSIP/SI information confirmation and watching information generation unit for confirming PSIP/SI information received from the outside, and generating viewer's watching information of the personal information setting unit in a predetermined format when a viewer watches TV;
a database input unit for storing the watching information in an inner storage unit;
a preference information processor for converting watching information of each viewer, stored in the database input unit, into divided input patterns using a fuzzy membership function and analyzing the input patterns, to extract information on a program with a high degree of preference from the analyzed result; and
a screen output unit for outputting preference program information of each viewer on a screen.

2. The program recommendation system in an EPG application, as claimed in claim 1, wherein the personal information setting unit restricts programs by viewers.

3. The program recommendation system in an EPG application, as claimed in claim 2, wherein the personal information setting unit receives the ID and password of a viewer, and only when they match stored ones, allows the viewer to start to watch TV.

4. The program recommendation system in an EPG application, as claimed in one of claims 1, 2, and 3, wherein the personal information setting unit compares a program rating included in the PSIP/SI information with the age of a viewer to restrain the viewer from watching a corresponding program.

5. The program recommendation system in an EPG application, as claimed in claim 1, wherein the PSIP/SI information confirmation and watching information generation unit confirms PSIP/SI information among transport streams (TS) received from an external digital broadcasting signal, and converts it into a predetermined data format to easily connect a preference program among the PSIL/SI information.

6. The program recommendation system in an EPG application, as claimed in claim 1 or 5, wherein the PSIP/SI information confirmation and watching information generation unit configures and generates the broadcasting station that provides a TV program a viewer has watched, the genre of the program, the performer of the program, and the day and time when the viewer watched the program into single watching information.

7. The program recommendation system in an EPG application, as claimed in claim 1, wherein the database input unit assigns a number to each of the items of the viewer's watching program information, generated by the PSIP/SI information confirmation and watching information generation unit, using a preference information generation table, and then inputs the number to the database input unit.

8. The program recommendation system in an EPG application, as claimed in claim 1, wherein the preference information processor comprises:
an input division unit for converting watching information of each viewer, stored in the data input unit, into divided input patterns using a fuzzy membership function; and
a pattern searching unit for searching the divided input patterns for a pattern having a predetermined high frequency;
a pattern discerning unit for detecting a difference among the patterns using a pattern discernibility function, to output the difference in the form of combinations of OR and AND;
a pattern condensing unit for condensing the result of the pattern discerning unit; and
a neural network construction unit for forming the initial structure of a neural network from the result of the pattern condensing unit, and processing preference information of each viewer at any time through a series of procedures to output the processed preference program information when the viewer logs in.

9. The program recommendation system in an EPG application, as claimed in claim 8, wherein the neural network construction unit receives viewer's preference information represented in m×n numbers including n items and m inputs from the database input unit to construct a basic neural network, trains the neural network, analyzes characteristics of a preference program of a viewer to transmit information on the preference program to the screen output unit, and updates a new preference signal through re-training when the new preference information is inputted.

10. The program recommendation system in an EPG application, as claimed in claim 1, wherein the screen output unit outputs each viewer's preference program information, updated by the preference information processor, when the viewer watches TV, overlaying a main broadcasting image with the preference program information.

11. The program recommendation system in an EPG application, as claimed in claim 1, wherein the screen output unit outputs preference program information on a part of the screen at the request of a viewer.

12. The program recommendation system in an EPG application, as claimed in claim 1, wherein, in the case that a program a viewer prefers broadcasts when the viewer logs in or while the viewer watches TV, the screen output unit overlays the program on a main broadcasting program on the screen to output the program for a predetermined period of time.

13. A program recommendation method in an EPG application, which receives PSIP/SI and programming information on digital broadcasting and provides a program recommendation service to viewers in the EPG application, the method comprising:
(a) receiving personal information setting in order to set information of each viewer;
(b) confirming the received PSIP/SI information and generating watching information through a viewer watching TV in a predetermined format;
(c) inputting the generated watching information to a database;
(d) converting watching information of each viewer, stored in the database input unit, into divided input patterns using a fuzzy membership function, analyzing the input patterns, and extracting information on a program with a high degree of preference from the analyzed result; and
(e) outputting preference program information of each viewer on a screen in order to recommend the program.

14. The program recommendation method in an EPG application, as claimed in claim 13, wherein (a) comprises:
(f) logging in a terminal for receiving digital broadcasting to be provided with preference program information of each viewer through the terminal; and
(g) restricting programs by viewers.

15. The program recommendation method in an EPG application, as claimed in claim 14, wherein the log-in procedure in (f) is carried out in a manner such that a viewer inputs his/her ID and password to the terminal when the viewer starts to watch TV.

16. The program recommendation method in an EPG application, as claimed in claim 15, wherein, in (g), program rating included in the PSIP/SI information is compared with the age of the viewer to restrain the viewer from watching a corresponding program by the terminal.

17. The program recommendation method in an EPG application, as claimed in claim 13, wherein (b) comprises;
(h) confirming the PSIP/SI information supported by digital broadcasting; and
(i) generating program watching information through a viewer watching TV.

18. The program recommendation method in an EPG application, as claimed in claim 17, wherein (h) comprises analyzing PSIP/SI information among transport streams (TS) of digital broadcasting, inputted to the terminal, and converting it into a predetermined data format to connect a preference program among the PSIL/SI information.

19. The program recommendation method in an EPG application, as claimed in claim 18, wherein in (i), the broadcasting station that provides a TV program a viewer watched, the genre of the program, the performer of the program, and the day and time when the viewer watched the program are configured and generated into single watching information.

20. The program recommendation method in an EPG application, as claimed in claim 13, wherein (c) comprises assigning a number to each of the items of the viewer's watching program information, generated by a PSIP/SI information confirmation and watching information generation unit, using a preference information generation table, and then inputting the number to the database input unit whenever the corresponding program is watched.

21. The program recommendation method in an EPG application, as claimed in claim 13, wherein (d) comprises receiving viewer's preference information represented in m×n numbers including n items and m inputs from the database input unit to construct a basic neural network, training the neural network, analyzing characteristics of a preference program of a viewer to transmit information on the preference program to the screen output unit, and updating a new preference signal through re-training when the new preference information is inputted.

22. The program recommendation method in an EPG application, as claimed in claim 13, wherein (e) comprises:
(j) automatically outputting each viewer's preference program information, processed by a preference information processor, on the screen when the viewer watches TV, by overlaying the preference program information on a main broadcasting program; and
(k) outputting the preference program information on a part of the screen at the request of a viewer.

23. The program recommendation method in an EPG application, as claimed in claim 22, wherein, (j) comprises automatically outputting information on the program on the screen for a predetermined period of time through the terminal in the case that a program a viewer prefers broadcasts when the viewer logs in the terminal or while the viewer watches TV.
